(19) United States
(12) Patent Application Publication
(10) Pub. No.: US 2015/0159072 A1
(43) Pub. Date: Jun. 11, 2015

(54) OXYGEN SCAVENGER FOR DRILLING FLUIDS

(71) Applicant: CANADIAN ENERGY SERVICES L.P., Calgary (CA)

(72) Inventor: Jonathan Robert HALE, Calgary (CA)

(21) Appl. No.: 14/564,547

(22) Filed: Dec. 9, 2014

Related U.S. Application Data
(60) Provisional application No. 61/914,173, filed on Dec. 10, 2013.

(51) Int. Cl. C09K 8/06

(52) U.S. Cl. CPC C09K 8/06

(57) ABSTRACT

There is provided the use of alkylhydroxylamines (AHA), and in particular, N,N-diethylhydroxylamine (DEHA), as an oxygen scavenger for reducing free dissolved oxygen in drilling fluid which is substantially free of erythorbate, erythorbic acid, or stereoisomers thereof. The AHA may be used to reduce the free dissolved oxygen in order to reduce undesirable corrosion or degradation caused by free dissolved oxygen. The AHA may be combined with a suitable diluent and/or antifreeze.

### CROSS REFERENCE TO RELATED APPLICATIONS

This application claims the benefit of priority of U.S. Provisional Patent Application No. 61/914,173 filed Dec. 10, 2013, which is incorporated herein by reference in its entirety.

### FIELD

The present disclosure relates generally to oxygen scavengers for drilling fluids used in the recovery of oil and gas.

### BACKGROUND

Drilling fluids often contain dissolved and entrained air which enters the fluids when its components are mixed and when the fluid circulates through the drill string into the wellbore. Dissolved oxygen and entrained air are undesirable in drilling fluids. The presence of oxygen in the fluid drastically increases the rate of corrosion and deterioration of metal surfaces in the drill string, casing, and associated equipment as compared to fluids which do not contain oxygen. This may manifest as general oxidative attack, pitting, crevice corrosion, and/or under-deposit corrosion. These are major factors in equipment failure.

Dissolved oxygen can also lead to free radical-based decomposition of drilling fluid additives, particularly polymeric additives.

To reduce dissolved oxygen, it is recommended that water be added to drilling fluid and mixed as far from the main pump suction as possible. Other physical adjustments can be made to the circulation system to reduce air entrapment (see e.g. H. E. Bush (1974), Treatment of Drilling Fluid to Combat Corrosion. Paper Number SPE 5123, American Institute of Mining, Metallurgical, and Petroleum Engineers). Adding water to hot mud allows the heat from the mud to reduce the amount of dissolved oxygen in the cooler water. However, dissolved oxygen still enters drilling fluid via surface interfaces, despite precautions to reduce unnecessary aeration.

Mechanical deaeration can be used to remove some bulk oxygen from drilling fluids, but chemical additives are generally required to achieve sufficiently low levels of dissolved oxygen required to reduce corrosion and degradation. These chemical additives, termed “oxygen scavengers”, are generally reducing agents that are oxidized by reacting with free dissolved oxygen. In doing so, the oxygen scavenger chemically sequesters the dissolved oxygen so that it is no longer available to cause undesirable corrosion or degradation. Common oxygen scavengers including sulfites, hydrazines, and erythorbates.

Drilling fluids are used in a variety of conditions such as high pressure, high temperature environments, or shale which are subject to swelling and absorption of the drilling fluid. These environments require specialized fluids. Not all oxygen scavengers are compatible or effective with drilling fluid environments.

Some oxygen scavengers are inactivated by heat, for example. U.S. Patent Publication No. 2012/0118569 addresses the issue of the heat labile nature of erythorbate in a completion fluid, and describes methods of reducing dissolved oxygen in the completion fluid using a blend of erythorbate and an alkylhydroxylamine, wherein the alkylhydroxylamine stabilizes the erythorbate at high temperatures. U.S. Patent Publication No. 2013/0178398 discloses completion brines containing a blend of the same.

Some oxygen scavengers are not compatible with salts. Brines are commonly used to prevent or reduce shale swelling in clay formations but may also reduce the effectiveness of some oxygen scavengers, such as sulfites.

Accordingly, there is a need for oxygen scavengers that are compatible with drilling applications.

### SUMMARY

It is an object of the present disclosure to obviate or mitigate at least one disadvantage of previous approaches.

In one aspect, there is provided a use of an alkylhydroxylamine as an oxygen scavenger in drilling fluid for reducing dissolved oxygen in the fluid, wherein the drilling fluid is substantially free of erythorbate, erythorbic acid, or a stereoisomer thereof.

In another aspect, the alkylhydroxylamine may be used in conjunction with a catalyst. The catalyst improves the oxygen scavenging ability of the alkylhydroxylamine. Any catalyst suitable for use with alkylhydroxylamine may be used and may include for example hydroquinone and Gallic acid.

In another aspect, there is provided a use of a composition comprising an alkylhydroxylamine and an acceptable diluent for reducing dissolved oxygen in drilling fluid, wherein the drilling is substantially free of erythorbate, erythorbic acid, or a stereoisomer thereof.

In a further aspect, the alkylhydroxylamine is N,N-diethylhydroxylamine (DEHA).

In a further aspect, the AHA is mixed with an antifreeze.

In a further aspect, the drilling fluid is a brine. The brine may comprise calcium salts. In a further aspect, the brine drilling fluid is a heavy brine.

In one aspect, there is provided a method of reducing dissolved oxygen in drilling fluid, comprising adding an AHA to drilling fluid, wherein the drilling fluid is substantially free of erythorbate, erythorbic acid, or a stereoisomer thereof. In one embodiment, the step of adding may comprise adding the AHA as a compound, as a composition mixed with a catalyst, as a composition mixed with a diluent, or as a composition premixed with antifreeze, with or without a catalyst or further diluent. In one embodiment, the AHA may be DEHA.

Other aspects and features of the present disclosure will become apparent to those ordinarily skilled in the art upon review of the following description of specific embodiments.

### DETAILED DESCRIPTION

Generally, the present disclosure relates to the use of alkylhydroxylamines as oxygen scavengers in drilling fluids and in particular in brine fluids.

In one aspect, there is provided a use of alkylhydroxylamines (AHA) for reducing dissolved oxygen in drilling fluid, wherein the drilling fluid is substantially free of erythorbate, erythorbic acid, or a stereoisomer thereof. The AHA may be added into the drilling fluid as a compound, as a composition mixed with a diluent, or as a composition mixed with antifreeze, with or without further diluent.

The AHA when used as an oxygen scavenger reacts with and sequesters free dissolved oxygen. This is desirable to prevent or reduce corrosion (e.g. of metal parts), and/or to reduce free-radical induced decomposition (e.g. of additives, such as polymeric additives).

The AHA may be, for example, isopropylhydroxylamine, diethylhydroxylamine (DEHA), tertbutylhydroxylamine, phenylhydroxylamine, cyclohexylhydroxylamine, or benzylhydroxylamine. Other suitable AHAs would be known to a skilled person.

In one aspect, the alkylhydroxylamine is DEHA.

The AHA may be used to reduce the dissolved oxygen level to preferred levels of 3 mg/L or less, 2 mg/L or less, 1 mg/L or less, 0.5 mg/L or less, or 0.25 mg/L or less. The AHA may be used to reduce the dissolved oxygen level to 10 ppm or less. In one aspect, the AHA is used for reducing the dissolved oxygen in the drilling fluid to a level of 2 mg/L or less. These levels may be the levels measured in fluid going downhole. A skilled person would be aware of an acceptable level of dissolved oxygen that would be tolerable in the drilling fluid dependent upon the intended application, and could readily adjust the amount of AHA accordingly to achieve this.

The AHA may be used to reduce dissolved oxygen to the desired level within a desired time frame, such as within 30 minutes or less, 60 minutes or less, or 72 hours or less. In one aspect, dissolved oxygen is reduced to the desired level in 30 minutes or less.

The AHA may also be used to hold dissolved oxygen at the desired level for a desired period of time, such as for 30 minutes or more, 60 minutes or more, or 72 hours or more. In one aspect, dissolved oxygen is held at the desired level for at least 72 hours.

In other aspects, the AHA is used in the drilling fluid in an amount of 20 kg/m³ or less, 10 kg/m³ or less, 5 kg/m³ or less, 1 kg/m³ or less, or 0.5 kg/m³ or less.

It has been found in testing that usage may be below 12 L/m³. In one aspect, it may be below 6.0 L/m³ and in a further aspect, may be below 1.5 L/ m³. One range of amount of AHA is between 1.5-6.0 L/m³ but can be above or below this range as required, depending on a number of factors including the specific drilling fluid and formation.

The amount of AHA used will, in some embodiments, be determined by the ability of the additive(s) to maintain sufficiently low dissolved oxygen content in the drilling fluid such that corrosion rates, (e.g. as monitored using corrosion rings and in accordance with API RP 13B-1, Fourth Edition, March 2009, Annex E) are maintained under 50 mpy. This will be achieved through the use of AHA, one or more corrosion inhibitor(s), or a combination of the two means of corrosion control. The acceptable corrosion rate can be determined by application. The corrosion rate may be 50 mpy, 40 mpy, 30 mpy, 25 mpy, 20 mpy, 15 mpy, 10 mpy, or 5 mpy. In some applications, a corrosion rates under 25 mpy may be desirable.

The AHA may be added to the drilling fluid in combination with a catalyst. The catalyst improves the oxygen scavenging ability of the AHA. The catalyst may be any known catalyst that is compatible with AHA and includes, for example, hydroquinone, gallic acid, copper, benzoquinone, 1,2-naphthoquinone-4-sulfonic acid, pyrogallol and t-butylcatechol. The amount of catalyst will depend on the specific AHA and catalyst selected as well as the composition of the drilling fluid. In one aspect, less than 1000 ppm of catalyst is added.

The drilling fluid may be of any conventional type which is well known within the field. In one aspect, the drilling fluid is a brine. Brines may be used for a number of reasons, such as to increase density and/or to inhibit shale hydration and swelling. A skilled person would be aware of brine fluids that would be suitable for use as drilling fluids. In one aspect, the drilling fluid is a heavy brine. In a further aspect, the brine comprises calcium salts.

The drilling fluid may include conventional additives. These may include surfactants, emulsifiers, fluid loss control additives, biocides, high temperature stabilizers, and descalers. Other potential additives include defoamers, viscosifiers, flocculating polymers (to effectively reduce the solids content of the fluid), lubricants (both liquid filming and solid ball-bearing type), LCM (loss of circulation material), grouting and wellbore stability additives, barite or calcium carbonate for weight in an unexpected well control situation, pH or alkalinity control additives.

One particular additive that may be used in SC-202, which is a scale control additive. SC-202 is a proprietary phosphonic acid and alkylamine mixture. Its function is to control unwanted precipitation of scales when brine fluids, especially those containing calcium, mix with connate water.

In another aspect, there is provided a use of a composition comprising an AHA, such as N,N-diethylhydroxylamine (DEHA), and an acceptable diluent for reducing dissolved oxygen in drilling fluid, wherein the drilling fluid is substantially free of erythorbate, erythorbic acid, or a stereoisomer thereof. In one aspect, the diluent may be water.

In a further aspect, the composition may include antifreeze. The antifreeze may be any compound (or mixture thereof) with suitable antifreeze properties, which is compatible with drilling operations, and which does not greatly inhibit AHA oxygen scavenging activity. The antifreeze may be selected based on application and environmental factors, such as temperature at the drilling site and composition of the drilling fluid. A skilled person could readily select an appropriate antifreeze compound to achieve a desired crystallization point for the drilling fluid, and which would not inhibit oxygen scavenging activity of the AHA in the drilling fluid. Examples of antifreeze including methanol, ethanol, and ethylene glycol. The antifreeze may be used alone or in combination with a suitable diluent such as water.

In one aspect, the composition contains antifreeze in an amount of 5 to 35%, 10 to 30%, or 15 to 25%, based on volume/volume. In certain aspects, the composition may comprise about 16% antifreeze, about 20% antifreeze, or about 24% antifreeze. By “about” is meant plus or minus 10%.

The amount of antifreeze would be adjusted for the specific application, for example, depending on the season, or the temperature at the drilling site. A skilled person could readily select antifreeze amounts required to achieve a desired crystallization point for the drilling fluid. In one aspect, the antifreeze is present in an amount sufficient to yield a crystallization point for the composition of −20° C. or less, 25° C. or less, −30° C. or less, −35° C. or less, or −40° C. or less. In one aspect, the crystallization point is about −40° C.

In one specific embodiment, the composition comprises 15 to 20% by volume of an 85% DEHA solution, mixed with a sufficient amount of ethylene glycol (e.g. provided as an 80:20 stock solution by volume) to achieve a crystallization point of −40° C. or lower.

In one aspect, the antifreeze is mixed with water in a ratio range of from 80:20 to 60:40. The specific range will depend on the particular application and environmental factors for use of the drilling fluid and appropriate ratios may fall outside this range.

In one aspect, the drilling fluid is stable and singled-phase after the composition is added. It may be stable and single phase following one or more rounds of freezing and thawing.

### EXAMPLE 1

### Preparation of Alkaline Brine

An alkaline brine was prepared to simulate the drilling environment. 3 L of 30% CaCl₂ brine was prepared as follows, and allowed to cool to room temperature.

Approximately 4g of soda pearls was mixed in 100 mL of water, and adjustments were made such that when a drop of this alkaline solution was added to a sample of the 30% CaCl₂ brine, no solid precipitate formed. The pH of the CaCl₂ brine solutions (measured with calibrated pH meter) was then raised to 10 to simulate the drilling fluid environment, by adding the alkaline solution drop-wise while the brine was stirring. Density of the alkaline brine was measured by use of a hydrometer, and found to be 1.246 kg/m3.

250 mL Erlenmeyer flasks were labeled according to the oxygene scavenger to be added, and appropriate amounts of the descaling agent, SC-202, were added to the appropriate flasks (except for negative controls), followed by 250 mL of brine (volume measured by weight).

### EXAMPLE 2

### Test Data for Oxygen Scavengers

Each flask was equipped with a magnetic stirring rod, stopper, and placed on a stir plate. Solutions began stirring at 2 minute intervals to create aeration and scavenger was added as stirring began. The following oxygen scavengers were tested, one per flask: N,N-diethylhydroxylamine (DEHA), uncatalyzed sodium sulphite, sodium erythorbate, catalyzed sodium sulphite, and liquid ammonium bisulphate (WO).

Testing with DEHA involved using an 85% stock solution as the additive and the L/m³ units refer to this stock solution. The density of this stock solution is about 0.9, kg/m³ .

Oxygen content of each solution was measured after 30, 60, and 120 minutes, and at 17 hours. Stirring was ceased after 60 minutes.

Table 1 depicts oxygen saturation data for two control samples, to which no scavenger was added in order to establish baseline data.

TABLE 1
Control

| With SC-202 (2.5 L/m³) pH 9.8 | | | | Without SC-202 pH 10 | | | |
|---|---|---|---|---|---|---|---|
| | | [Oxygen] | Temp | | | [Oxygen] | Temp |
| Time | | (mg/L) ± 0.3 | (° C.) | Time | | (mg/L) ± 0.3 | (° C.) |
| 30 | min | 4.89 | 23.8 | 30 | min | 4.65 | 24.0 |
| 60 | min | 4.86 | 23.3 | 60 | min | 4.68 | 23.6 |
| 120 | min | 4.89 | 23.0 | 120 | min | 4.83 | 23.0 |
| 17 | hrs | 4.62 | 20.1 | 15 | hrs | 4.55 | 20.1 |

Table 2 depicts oxygen saturation data for N,N-diethylhydroxylamine samples (30% CaCl₂ pH 10) with and without SC-202.

TABLE 2
N,N-diethylhydroxylamine (0.5 L/m³)

| With SC-202 (2.5 L/m³)pH 9.9 | | | | Without SC-202 pH 10 | | | |
|---|---|---|---|---|---|---|---|
| | | [Oxygen] | Temp | | | [Oxygen] | Temp |
| Time | | (mg/L) ± 0.3 | (° C.) | Time | | (mg/L) ± 0.3 | (° C.) |
| 30 | min | 0.25 | 24.1 | 30 | min | 0.26 | 23.4 |
| 60 | min | 0.31 | 23.8 | 60 | min | 0.40 | 22.9 |
| 120 | min | 0.38 | 23.1 | 120 | min | 0.40 | 22.6 |
| 17 | hrs | 0.21 | 20.8 | 15 | hrs | 0.31 | 20.1 |

As evidenced from this data, DEHA is compatible with the SC-202 descaler, as its presence does not significantly impact the oxygen scavenging ability of DEHA.

Table 3 depicts oxygen saturation data for sodium sulphite samples (30% CaCl₂ pH10).

TABLE 3
Sodium Sulphite (0.5 kg/m³)

| With SC-202 (2.5 L/m³) pH 9.9 | | | | Without SC-202 pH 10 | | | |
|---|---|---|---|---|---|---|---|
| | | [Oxygen] | Temp | | | [Oxygen] | Temp |
| Time | | (mg/L) ± 0.3 | (° C.) | Time | | (mg/L) ± 0.3 | (° C.) |
| 30 | min | 4.75 | 23.3 | 30 | min | 3.9 | 23.3 |
| 60 | min | 4.43 | 22.9 | 60 | min | 1.61 | 23.1 |
| 120 | min | 3.97 | 22.3 | 120 | min | 0.74 | 22.3 |
| 17 | hrs | 3.60 | 20.3 | 15 | hrs | 0.40 | 20.7 |

This data makes clear that the presence of SC-202 negatively impact the oxygen scavenging ability of sodium sulphite.

Table 4 depicts oxygen saturation data for sodium erythorbate samples (30% CaCl₂ pH10).

TABLE 4
Sodium Erythorbate (0.5 kg/m³)

| With SC-202 (2.5 L/m³) pH 9.9 | | | | Without SC-202 pH 10 | | | |
|---|---|---|---|---|---|---|---|
| | | [Oxygen] | Temp | | | [Oxygen] | Temp |
| Time | | (mg/L) ± 0.3 | (° C.) | Time | | (mg/L) ± 0.3 | (° C.) |
| 30 | min | 0.45 | 24.6 | 30 | min | 0.43 | 23.7 |
| 60 | min | 0.17 | 25.1 | 60 | min | 0.28 | 23.3 |
| 120 | min | 0.23 | 24.0 | 120 | min | 0.32 | 22.5 |
| 17 | hrs | 0.33 | 22.8 | 15 | hrs | 0.31 | 20.6 |

The presence of SC-202 does not appear to significantly impact the oxygen scavenging activity of sodium erythorbate.

Table 5 presents oxygen saturation data for catalyzed sodium sulphite samples (30% CaCl₂ pH10).

TABLE 5
Catalyzed Sodium Sulphite (0.5 kg/m³)

| With SC-202 (2.5 L/m³) | | | | Without SC-202 | | | |
|---|---|---|---|---|---|---|---|
| | | [Oxygen] | Temp | | | [Oxygen] | Temp |
| Time | | (mg/L) ± 0.3 | (° C.) | Time | | (mg/L) ± 0.3 | (° C.) |
| 30 | min | 4.43 | 22.5 | 30 | min | 3.01 | 22.7 |
| 60 | min | 4.20 | 23.0 | 60 | min | 2.93 | 23.1 |
| 120 | min | 4.19 | 24.1 | 120 | min | 2.45 | 24.1 |
| 17 | hrs | 4.02 | 23.0 | 15 | hrs | 1.90 | 23.0 |

As with uncatalyzed sodium sulphite, the presence of SC-202 significantly impacts the oxygen scavenging effectiveness of catalyzed sodium sulphite

Table 6 presents oxygen saturation data for liquid ammonium bisulphate (WO) samples (30% CaCl₂ pH10).

TABLE 6
Liquid Ammonium Bisulphate (0.5 L/m³)

| With SC-202 (2.5 L/m³) | | | | Without SC-202 | | | |
|---|---|---|---|---|---|---|---|
| | | [Oxygen] | Temp | | | [Oxygen] | Temp |
| Time | | (mg/L) ± 0.3 | (° C.) | Time | | (mg/L) ± 0.3 | (° C.) |
| 30 | min | 4.08 | 24.2 | 30 | min | 3.20 | 24.2 |
| 60 | min | 4.05 | 24.1 | 60 | min | 2.70 | 25.4 |
| 120 | min | 3.95 | 24.0 | 120 | min | 2.35 | 26.5 |
| 17 | hrs | 4.15 | 20.6 | 15 | hrs | 2.75 | 20.6 |

It is clear that liquid ammonium bisulphate is not particular effective as an oxygen scavenger in calcium brine, with or without SC-202 descaler.

### EXAMPLE 3

### Comparisons of Oxygen Scavengers

The following tables show comparisons of the effectiveness of oxygen scavengers. The amounts tested in each case have been selected with a cost basis in mind. For reference, sodium erythorbate is roughly twice the cost of sodium sulphite; while an 85% DEHA stock solution is roughly 2.5 times the cost of sodium sulphite.

Table 7 presents a comparison of the effectiveness of uncatalyzed sodium sulphite and sodium erythorbate.

TABLE 7

| 1.5 kg/m³ uncatalyzed | | | | | | | |
|---|---|---|---|---|---|---|---|
| Sodium Sulphite | | | | 0.5 kg/m³ Sodium Erythorbate | | | |
| | | [Oxygen] | Temp | | | [Oxygen] | Temp |
| Time | | (mg/L) ± 0.3 | (° C.) | Time | | (mg/L) ± 0.3 | (° C.) |
| 30 | min | 1.34 | 24.2 | 30 | min | 0.22 | 23.3 |
| 60 | min | 1.43 | 24.9 | 60 | min | 0.12 | 22.9 |
| 120 | min | 1.04 | 23.3 | 120 | min | 0.15 | 22.2 |
| 17 | hrs | 0.45 | 21.9 | 17 | hrs | 0.20 | 22.0 |

Sodium erythorbate is a more effective oxygen scavenger than uncatalyzed sodium sulphite in calcium brine.

Table 8 presents a comparison of the effectiveness uncatalyzed sodium sulphite and N,N-diethylhydroxylamine (DEHA). Again, testing with DEHA involved using an 85% stock solution as the additive.

TABLE 8

| 1.8 kg/m³ uncatalyzed | | | | | | | |
|---|---|---|---|---|---|---|---|
| Sodium Sulphite | | | | 0.5 L/m³ N,N-diethylhydroxylamine | | | |
| | | [Oxygen] | Temp | | | [Oxygen] | Temp |
| Time | | (mg/L) ± 0.3 | (° C.) | Time | | (mg/L) ± 0.3 | (° C.) |
| 30 | min | 1.30 | 23.8 | 30 | min | 0.23 | 23.5 |
| 60 | min | 1.05 | 23.4 | 60 | min | 0.18 | 23.6 |
| 120 | min | 0.33 | 22.4 | 120 | min | 0.16 | 22.9 |
| 17 | hrs | 0.38 | 21.8 | 17 | hrs | 0.22 | 21.9 |

DEHA is more effective as an oxygen scavenger than sodium sulphite at all time points tested. DEHA also scavengers oxygen much more quickly than sodium sulphite, as evidenced from the greatly reduced oxygen levels at 30- and 60-minute time points.

Table 9 presents comparative data for certain oxygen scavengers. The amounts tested have again been selected for comparison based on cost.

0.5 kg/m³ sodium sulphite was chosen based on field usage. The 0.126 L/m³ of DEHA and 0.17 kg/m³ sodium erythorbate were chosen to come in at slightly under the cost (about 2/3 the cost) of the 0.5 kg/m³ sodium sulphite. Finally, the lower amount of DEHA, 0.0378 L/m³, was a low concentration found to just out-perform the sodium sulphite at 0.5 kg/m³, and hence provides an indication of how much DEHA is required to match the performance of sodium sulphite.

TABLE 9

| | 30 min | | 60 min | | 120 min | | 17 hrs | |
|---|---|---|---|---|---|---|---|---|
| | [O₂] | | [O₂] | | [O₂] | | [O₂] | |
| | (mg/ | Temp | (mg/ | Temp | (mg/ | Temp | (mg/ | Temp |
| Additive | L) | (° C.) | L) | (° C.) | L) | (° C.) | L) | (° C.) |
| [0.5 kg/m³] | 3.43 | 22.8 | 2.61 | 23.2 | 1.05 | 23.8 | 0.40 | 21.3 |
| Sodium | | | | | | | | |
| Sulphite | | | | | | | | |
| [0.126 L/m³] | 1.26 | 22.6 | 0.23 | 23.3 | 0.19 | 24.1 | 0.25 | 21.0 |
| DEHA | | | | | | | | |
| [0.0378 L/m³] | 2.87 | 22.6 | 1.64 | 23.3 | 0.75 | 23.5 | 0.38 | 21.4 |
| DEHA | | | | | | | | |
| [0.17 kg/m³²] | 0.45 | 22.8 | 0.18 | 23.6 | 0.16 | 23.9 | 0.19 | 21.2 |
| Sodium | | | | | | | | |
| Erythorbate | | | | | | | | |

Both amounts of DEHA were more effective at all time points than a significantly larger quantity of sodium sulphite, reflective of sodium sulphite's poor oxygen scavenging in calcium brines, and DEHA's superior performance.

Although sodium erythorbate was most effective at the 30-minute time point, it is notable that a smaller amount of DEHA (0.126 L/m³) was comparably effective at 60 minutes (0.23 mg/L dissolved oxygen for DEHA vs. 0.18 mg/L for sodium erythorbate at 60 minutes) and 120 minutes (0.19 mg/L dissolved oxygen for DEHA vs. 0.16 mg/L for sodium erythorbate at 120 minutes).

It is significant that an amount of DEHA that is about an order of magnitude lower than that of sodium sulphite (0.0378 L/m³ DEHA vs. 0.5 kg/m³ sodium sulphite) worked better than sodium sulphite at 120 minutes (0.75 mg/L dissolved oxygen for DEHA vs. 1.05 mg/L dissolved oxygen for sodium sulphite).

Also notable is the data at 17 hours, wherein a very low amount of DEHA (0.0378 L/m³) worked about as well as sodium sulphite (0.38 mg/L dissolved oxygen for DEHA vs. 040 mg/L dissolve oxygen for sodium sulphite), and that the amount of dissolved oxygen achieved by 0.0378 kg/m³ of DEHA was only twice that achieved by much higher amount (0.17 kg/m³) of sodium erythorbate.

Table 10 presents consolidated comparative data for oxygen scavengers. Again, the amounts selected are based on cost.

TABLE 10

| | | | 30 min | 60 min | 120 min | 960 min |
|---|---|---|---|---|---|---|
| Additive | Loading | | [O₂](mg/L) | [O₂](mg/L) | [O₂](mg/L) | [O₂](mg/L) |
| Control (30% CaCl₂, with pH | — | | 4.89 | 4.86 | 4.89 | 4.62 |
| adjusted to 10.0 using NaOH) | | | | | | |
| Sodium Sulphite (uncatalysed) | 0.5 | kg/m³ | 3.43 | 2.61 | 1.05 | 0.4 |
| Sodium Sulphite (uncatalysed, | 0.5 | kg/m³ | 4.75 | 4.43 | 3.97 | 3.6 |
| with 2.5 L/m³ SC-202) | | | | | | |
| DEHA (with 2.5 L/m³ SC-202) | 0.5 | L/m³ | 0.25 | 0.31 | 0.38 | 0.21 |
| DEHA | 0.126 | L/m³ | 1.26 | 0.23 | 0.19 | n/a |
| DEHA | 0.0378 | L/m³ | 2.87 | 1.64 | 0.75 | n/a |
| Sodium Erythorbate | 0.17 | kg/m³ | 0.45 | 0.18 | 0.16 | 0.19 |
| WOS (ammonium bisulphate) | 0.5 | L/m³ | 3.2 | 2.7 | 2.35 | 2.75 |
| WOS (ammonium bisulphate, | 0.5 | L/m³ | 4.08 | 4.05 | 3.95 | 4.15 |
| with 2.5 L/m³ SC-202) | | | | | | |

— Measured at 22 ± 1C

In these data, 0.5 L/m³ DEHA was more effective than any other oxygen scavenger at 30 minutes. Beyond this time point, 0.5 L/m³ DEHA showed oxygen scavenging performance comparable to sodium erythorbate, even at 960 minutes. At the 60- and 120-minute time points, 0.126 L/m³ of DEHA performed similarly to sodium erythorbate.

0.0378 L/m³ of DEHA achieved oxygen reduction at 120 min that was better than much higher amounts of sodium sulphite (catalyzed and uncatalyzed) and ammonium bisulphate.

In summary, DEHA is surprisingly effective as an oxygen scavenger, compatible with other common additives in the fluid, and also surprisingly effective in brine drilling fluids. These qualities make it suitable for use as an oxygen scavenger in drilling fluids, without the need for addition of other oxygen scavengers.

### EXAMPLE

### Effects of Antifreezes on DEHA Oxygen Scavenging

Table 11 presents data from test on impact of antifreezes methanol and ethanol on the oxygen scavenging activity of DEHA. The solutions tested as additives were mixes of 30% by volume of DEHA (an 85% stock solution) with 70% by volume of ethanol (EtOH) or methanol (MeOH). These were added to the brine, as above, after aging for 48 hours at −20° C.

TABLE 11

| | 30 min | | 60 min | | 120 min | | 21 hrs | |
|---|---|---|---|---|---|---|---|---|
| | [O₂] | | [O₂] | | [O₂] | | [O₂] | |
| Additive | (mg/ | Temp | (mg | Temp | (mg/ | Temp | (mg/ | Temp |
| [L/m³] | L) | (° C.) | L) | (° C.) | L) | (° C.) | L) | (° C.) |
| Control | 4.35 | 22.4 | 4.41 | 22.7 | 4.44 | 22.8 | 4.38 | 21.4 |
| [0.0378] | 3.23 | 22.4 | 2.42 | 22.6 | 1.63 | 22.7 | 0.45 | 21.6 |
| DEHA | | | | | | | | |
| [0.0378] | 3.16 | 23.0 | 2.29 | 24.1 | 1.15 | 25.7 | 0.43 | 21.3 |
| DEHA in | | | | | | | | |
| EtOH | | | | | | | | |
| [0.0378] | 3.17 | 22.7 | 2.38 | 22.9 | 1.70 | 23.1 | 0.40 | 21.3 |
| DEHA in | | | | | | | | |
| MeOH | | | | | | | | |

As may be seen, neither methanol nor ethanol inhibited oxygen scavenging activity of DEHA. Indeed, DEHA appeared to work slightly better in ethanol than in its absence.

### EXAMPLE 5

### Crystallization Points and Stability of DEHA Blends

Three compositions comprising DEHA and antifreeze were made to test crystallization and stability characteristics.

Blend #1: 40% DEHA

30% Ethylene Glycol (80/20)

30% Water*

Blend #2: 40% DEHA

25% Ethylene Glycol (80/20)

35% Water*

Blend #3: 40% DEHA

20% Ethylene Glycol (80/20)

40% Water*

Reverse osmosis (RO) water was used for all three blends.

All three blends were mixed in an Erlenmeyer flask, starting with the RO water and ethylene glycol (EG), and the DEHA was added last. Each flask was covered with Parafilm, and the blend was mixed with a stir-bar set to a very low speed, just until the blend was homogeneous. This was done in order to decrease the exposure to air, thus helping to minimize the amount of oxygen incorporated into each blend.

Monitoring was carried out to ensure that the DEHA/water/ethylene glycol combination was miscible and stable, and to check the crystallization point. One desirable goal was to achieve a very low crystallization point (e.g. −40° C.) and no phase separation.

All three blends remained stable at ambient temperature for the five days they were observed.

Blends #1 and #2 remained stable at a constant temperature of −40° C., as well as after having gone through two freeze/thaw cycles. No phase separation was observed at all, and the blends remain homogeneous.

Blend #3 also remained stable overnight at a constant temperature of −40° C., however there was a small amount of crystallization observed after being in the −40° C. freezer over the weekend. However, this amount of crystallization did not subsequently increase, and in fact disappeared upon subsequent observation one day later.

Thus, the concentration of ethylene glycol can be reduced down to 25% (of an 80/20 mix) and stability is maintained.

Ethylene glycol can be further reduced to a lower concentration, in the range of 20-25%, as the blend with 20% ethylene glycol did remain stable at −40C overnight, and the amount of crystallization initially observed was quite minimal, and possibly due to temperature fluctuations.

### EXAMPLE 6

### AHA and Catalyst Blends

Testing was conducted on DEHA with one of hydroquinone or Gallic acid. This testing used a DEHA 85% stock solution at full strength. The test results set out below show that hydroquinone was more effective than gallic acid in improving oxygen scavenging in the base fluid. The formulation with DEHA and just under 1000 ml of hydroquinone showed a drop in oxygen concentration in 30% CaCl₂ brine, pH 9-10, from about 5.0 mg/L dissolved oxygen to 0.5 mg/L dissolved oxygen, after 5 minutes when treated with 0.5 L/m³ concentration of oxygen scavenger, at room temperature. At 0.05 L/m³ or higher concentrations of each scavenger injected into the 30% CaCl₂ brine, reaction rates are very rapid.

TABLE 12

| | O₂ (mg/L) | O₂ (mg/L) |
|---|---|---|
| Time (min) | DEHA (GA) | DEHA (HQ) |
| 0 | 5.01 | 5.00 |
| 5 | — | 3.99 |
| 20 | 4.88 | 3.05 |
| 60 | 4.71 | 1.90 |
| 90 | 4.62 | 1.98 |
| 120 | 4.51 | — |
| 150 | 4.62 | — |

Testing was also conducted using methyl ethyl ketoxime (Mekor 70) in both catalyzed and uncatalyzed solutions. 1 L/m3 Mekor 70 was injected into 30% CaCl₂ at pH of 9-10. 0.05 L/m³ of Melor 70 catalyzed with 1000 ppm hydroquinone was injected into 30% CaCl₂, at pH 9-10.

TABLE 13

| Time (min) | O₂ (mg/L Mekor 70 | O₂ (mg/L) Mekor (HQ) |
|---|---|---|
| 0 | 5.11 | 5.32 |
| 5 | 5.19 | 5.00 |
| 20 | 5.16 | 4.79 |
| 60 | 4.92 | |

Testing with DEHA and hydroquinone used a solution of water and ethylene glycol as a base fluid and added 30% CaCl₂. Amounts of DEHA and hydroquinone were tested for their oxygen scavenging ability and the results set out below.

Solution Preparation:

Solution A: 400 g solution of 80:20 (w/w %) of water to ethylene glycol was prepared using a top load balance (320 g water, 80 g ethylene glycol) δ=1.026 g/mL.

Solution B: 1.5 L of 30% CaCl₂, 575.4 g CaCl₂ in 1500 g water (pH 9-10, δ=1.2516 g/mL) was prepared and cooled to room temperature.

Solution C: 100g solutions of 5%, 10%, and 15% DEHA in solution A (w/w %) were created using top loading balance:

i) 5% solution: 5 g DEHA/95 g solution A;

ii) 10% solution: 10 g DEHA/90 g solution A;

iii) 15% solution: 15 g DEHA/85 g solution A.

Solution D: Using the analytical balance, hydroquinone (Hq) was weighed and added to 20 g of each batch of solution C, and to solution A:

i) 250 ppm Hq in 5% DEHA: 0.0050 g Hq/20 g Solution C(i);

ii) 250 ppm Hq in 10% DEHA: 0.0050 g Hq/20 g solution C(ii);

iii) 250 ppm Hq in 15% DEHA: 0.0050 g Hq/20 g solution C(iii);

iv) 250 ppm Hq (no DEHA): 0.0050 g Hq/20 g solution A;

v) 125 ppm Hq in 5% DEHA: 0.0025 g Hq/20 g solution C(i).

For each trial, 125.16 g (100 mL) of solution B was weighed out in a 250 mL beaker equipped with a magnetic stirring rod. At a stir rate of 60 rpm, 150 uL of solution D(i) was introduced using a micropipette, and a timer was set. After five minutes, the beaker was removed from the stir plate and the Dissolved Oxygen (DO) was recorded. This was repeated for solutions D(ii)-D(v). Note: DO readings, at time=0min, were taken from the stock beaker of solution B as to avoid altering initial volumes of 100 mL batches.

TABLE 14

| | | | O₂ | O₂ | Temp | Temp |
|---|---|---|---|---|---|---|
| | % | HQ | Initial | Final | Initial | Final |
| Trail | DEHA | (ppm) | (mg/L) | (mg/L) | (° C.) | (° C.) |
| 1 | 0 | 250 | 5.24 | 5.02 | 21.7 | 22.4 |
| *2 | 20 | 0 | 5.22 | 5.23 | 22.1 | 21.1 |
| 3 | 5 | 125 | 4.92 | 0.81 | 23.1 | 22.6 |
| 4 | 5 | 250 | 4.91 | 0.69 | 22.9 | 22.5 |
| 5 | 10 | 250 | 4.93 | 0.58 | 22 | 21.9 |
| 6 | 15 | 250 | 5.39 | 0.56 | 20 | 19.6 |
| 7 | 15 | 500 | 5.23 | 0.46 | 21.1 | 21.2 |
| 8 | 15 | 750 | 5.25 | 0.4 | 19.4 | 20 |
| 9 | 15 | 1000 | 5.35 | 0.36 | 19.2 | 20.5 |
| 10 | 20 | 500 | 5.31 | 0.42 | 19.3 | 20.9 |
| 11 | 20 | 750 | 5.42 | 0.37 | 19.2 | 20.6 |
| 12 | 20 | 1000 | 5.32 | 0.32 | 19.3 | 20.7 |
| **13 | 20 | 1000 | 5.31 | 0.31 | 19.2 | 21.4 |

Note: Trial 2 was 1.5 L/m³ of O2 ENERSCAV, not included in sample preparation above. [O₂] final was measured 5 minutes after scavenger had was added to solution. However readings took approximately 5 minutes to stabilize. Trial 3 took slightly longer than the rest of the samples for a stabilized O₂ reading to be reached. All trials are at 1.5 L/m³ of scavenger solution.

**This trial was run at 3 L/m³. A measurement was also taken at 120 minutes, 0.37 mg/L reading was recorded. All 20% DEHA solutions were made using premixed Enerscay.

In the preceding description, for purposes of explanation, numerous details are set forth in order to provide a thorough understanding of the embodiments. However, it will be apparent to one skilled in the art that these specific details are not required. The above-described embodiments are intended to be examples only. Alterations, modifications and variations can be effected to the particular embodiments by those of skill in the art without departing from the scope, which is defined solely by the claims appended hereto.

All references cited herein are incorporated by reference in their entirety.

What is claimed is:

1. A method of reducing dissolved oxygen in drilling fluid, comprising adding an alkylhydroxylamine (AHA) to the drilling fluid, wherein the drilling fluid is substantially free of erythorbate, erythorbic acid, or a stereoisomer thereof.

2. The method of claim 1 wherein the drilling fluid is a brine fluid.

3. The method of claim 2 where the AHA is N,N-diethylhydroxylamine (DEHA).

4. The method of claim 1, wherein the AHA reduces the free dissolved oxygen in the drilling fluid to 2 mg/L or less.

5. The method of claim 1, wherein the AHA reduces the free dissolved oxygen in the drilling fluid to 2 mg/L or less within 30 minutes.

6. The method of claim 1, wherein the AHA holds the dissolved oxygen in the drilling fluid to 2 mg/L or less for 72 hours.

7. The method of claim 1, wherein less than 20 kg/m³, or less than 10 kg/m³, or less than 1 kg/m³, or less than 0.5 kg/m³, of the AHA is used.

8. The method of claim 1, wherein less than 12 L/m³, or less than 6.0 L/m³, or less than 1.5 L/m³ of the AHA is used.

9. The method of claim 1 wherein the AHA further comprises a diluent, antifreeze or a catalyst.

10. The method of claim 9 wherein the catalyst is hydroquinone or gallic acid.

11. The method of claim 9, wherein the antifreeze is selected from the group consisting of methanol, ethanol, and ethylene glycol.

12. The method of claim 9, wherein the antifreeze is present in the composition in an amount of 5 to 35%, or 10 to 30%, or 15 to 25%, or about 16%, or about 20%, or about 24%, based on volume/volume.

13. The method of claim 9, wherein the antifreeze is present in the composition in an amount sufficient to yield a crystallization point for the composition of −20° C. or less, or -25° C. or less, or −30° C. or less, or −35° C. or less, or −40° C. or less.

14. The method of claim 1 wherein the drilling fluid is a brine drilling fluid.

15. The method of claim 14, wherein the brine drilling fluid comprises calcium salts.

16. The method of claim 14, wherein the brine drilling fluid is a heavy brine.

17. A brine drilling fluid comprising an alkylhydroxylamine (AHA) as an oxygen scavenger, wherein the drilling fluid is substantially free of erythorbate, erythorbic acid, or a stereoisomer thereof.

18. The brine drilling fluid of claim 17 wherein the AHA is N,N-diethylhydroxylamine (DEHA).

19. The brine drilling fluid of claim 17 further comprising one or more of a diluent, antifreeze, or a catalyst.
